(19) United States
(12) Patent Application Publication
(10) Pub. No.: US 2019/0221213 A1
(43) Pub. Date: Jul. 18, 2019

(54) METHOD FOR REDUCING TURN AROUND TIME IN TRANSCRIPTION

(71) Applicant: EZDI INC., Louisville, KY (US)

(72) Inventors: Nehal Shah, Louisville, KY (US); Chetan Parikh, Louisville, KY (US); Rahul Jagdishbhai Rawal, Gandhinagar (IN); Saurabh Jain, Shivpuri (IN); Kishan Pandey, Kushinagar (IN)

(21) Appl. No.: 16/005,847

(22) Filed: Jun. 12, 2018

(30) Foreign Application Priority Data
Jan. 18, 2018 (IN) 201811002069

(51) Int. Cl. G10L 15/26; G10L 15/04; G10L 15/01; G10L 15/22

(52) U.S. Cl. CPC G10L 15/26; G10L 15/22; G10L 15/01; G10L 15/04

(57) ABSTRACT

A computer implemented method for reducing the Turn around time (TAT) for transcription of audio source file, comprises steps of receiving source audio file and passing the source audio file through integrated Automatic Speech Recognition (ASR) engine and silent node detector for converting the source audio file to output text, improving the output text by machine learning, segmenting the output text file to text chunks at silent nodes, filtering and classifying the segmented text chunks to high confidence score chunks and low confidence score chunks, on basis of predetermined threshold confidence score, distributing the text chunks with low confidence score and corresponding audio chunks to multiple users for correction and merging the corrected text with the text chunks having the high confidence score to obtain a final single text output file that is synchronous with source audio file.

### IELD OF INVENTION

The present invention relates to a procedure for reducing the Turnaround time in transcription to a minimum.

More particularly, the invention relates to the procedure of converting speech to text, recognizing the errors in the text, segmenting and sending only the error text and corresponding audio file for correction to different transcriptionists and synchronously merging the corrected text to a single file once the correction/transcription is done.

### BACKGROUND

Transcription is the procedure of converting voice files into text document. The instant invention, demonstrates the procedure used in the field of medical transcription. The doctors and other paramedical healthcare professionals record the dictations and send it to the medical transcriptionist, for making a text report.

TAT (Turn around time)—In the field of medical transcription TAT is defined as the amount of time from the minute the transcriptionist receives the digital audio file to the time that a finished transcript is provided to the individual or company that supplied the file.

In order to reduce the TAT, medical transcription services were outsourced. This helped to reduce the cost of transcription significantly. As it became a very lucrative business, many players jumped into it. Due to competition, companies started exploring technology that can help them to reduce cost of production and reduce the turn-around-time of a dictation without compromising in quality. Speech to text conversion is adapted as with this process companies could provide fast service at a reasonably lower cost and without compromising the quality.

Speech Recognition enabled the medical transcriptionist, who previously had to listen to the audio and type words dictated by the doctor or healthcare professional, to just edit the draft created by the speech recognition machine. This increased the productivity of the transcriptionist and reduced the processing time of the file by 50%. With increased productivity of transcriptionist, the companies in transcription business were able to produce more and deliver transcripts quickly round the clock. Speech Recognition also helped in reducing the manpower, increasing the productivity and reducing the cost; however, the quality was either same as traditional transcription or poor. The synching of voice and text in the draft of speech recognition helped medical transcription editors to focus on the words that were highlighted while the dictation was played. The voice and text mapping enabled the system to process the feedback of a corrected word more precisely and the accuracy of the draft improved. This also helped the medical transcription editors to track the text with dictation and thus reduce the chances of skipping words or phrases which could impact the accuracy of the document. This is the practice that is currently being followed by all the leading speech recognition systems in transcription.

One of the approaches to reduce the TAT, would be to segment the source audio file and send it to multiple transcriptionists for transcription. However, a drawback with this approach is that during the segmentation there is a possibility that if the partition is done as per time frame, then a word may get segmented. For example, if audio size is 2 minutes long, the audio file can be divided into two chunks. The first chunk contains 0.00 to 1.00 and second chunk contains 1.00 to 2.00 audio. However, if a word spans between 0.59 second to 1.01 second, both transcriptionists will not be able to transcribe that word correctly. Here the probability of boundary error is very high. There will be many such errors at partition boundaries. One approach to overcome this problem is to use overlapping partitions, but using these may introduce error in merging process. The present invention uses “Silent Nodes” i.e. the points where there is no speech for partitioning the audio file. The audio file between one silent node to another is an independent audio file/chunk. Silent node detection avoids the boundary errors.

Furthermore, Silent node detection does not cost extra time penalty because it is already integrated with ASR. Using the silent node partition strategy, audio chunks will have uneven lengths. So, depending upon the list of available transcriptionists and their profile, different chunks can be sent to different transcriptionists to get the optimal TAT.

Furthermore, the TAT can be reduced by the approach used in the instant invention. In one of the embodiments the audio file and the corresponding text file is segmented/partitioned to small chunks and after these chunks are assigned confidence score, only the audio and text chunks with low confidence score is distributed to multiple transcriptionists. In the final step, both the texts are merged synchronously to a single text file.

### BRIEF SUMMARY OF THE INVENTION

A method and a system for producing transcripts according to the invention reduces the turnaround time for transcription and eliminates the time and quality inefficiencies. This is achieved by performing the steps mentioned hereafter. The sequence illustrated is preferred but is not mandatory and the individual steps can be performed independently or in different permutations and with addition or deletion of some steps. The major steps include-converting the source audio file to text using speech to text software, classifying the said text according to confidence score into texts having high and low confidence score and distributing only the audio and text segments having low confidence score to the transcription team in small segments so that the team members edit these segments in parallel and deliver the corrected transcript. The said corrected transcript(s) is then merged synchronously with the text having high confidence score (obtained in previous step and classified as text with high confidence score) to obtain a single text output file so that the resulting text file is an accurate transcript of the source audio file.

### BRIEF DESCRIPTION OF THE DRAWINGS

In the flowchart, like numbers represent similar steps. The flowcharts illustrate the embodiments of the instant invention.

FIG. 1 depicts the system/procedure for reducing TAT in transcription;

FIG. 2 illustrates a flow chart of a process that may be implemented for reducing TAT;

FIG. 3 illustrates an example of reducing TAT using the instant invention;

FIG. 4 is a graphical representation of the partitioning of the audio file at the silent nodes; and

FIG. 5 Depicts the procedure for synchronizing the text according to the source audio file.

### DETAILED DESCRIPTION

A method and a system for producing transcripts according to the invention reduces the turnaround time for transcription and eliminates the time and quality inefficiencies. This is achieved by performing the steps mentioned hereafter. The sequence illustrated is preferred but not mandatory and the individual steps can be performed independently or in different permutations and with addition or deletion of certain steps. The steps carried out are mentioned below in detail.

The first step is converting the source audio file to text file using speech to text convertor integrated with silent node detector; classifying the said converted text according to confidence score into texts having high confidence score (HCS) and low confidence score (LCS); distributing the text with LCS to multiple transcriptionists according to their expertise. Once the text with LCS is corrected by the transcriptionist(s), it is merged synchronously with the HCS according to the source audio file. This text file is called the final output text and may be sent for QA to correct any skipped error(s).

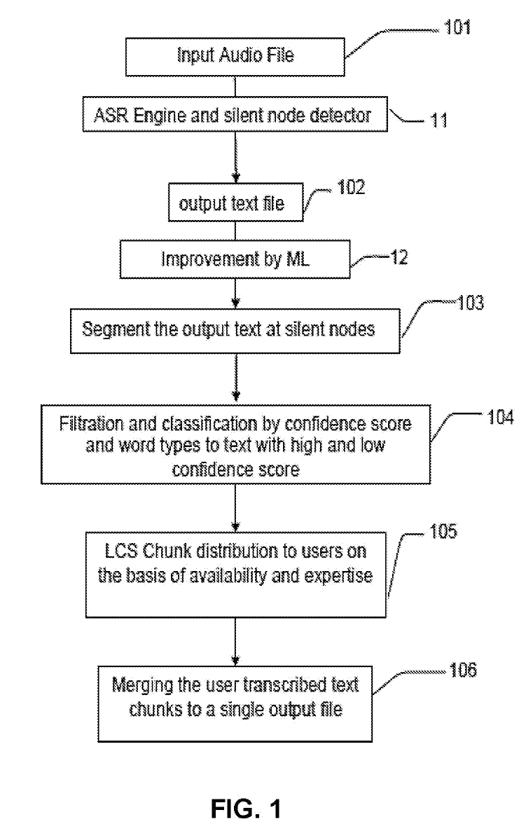

FIG. 1 depicts the main steps involved in the procedure for reducing TAT. The procedure begins by converting the audio file (101) to text by passing the audio file through integrated speech to text converter and silent node detector engine (11). Once the output text file is obtained in step (102), the improvement by machine learning (12) is applied to the said output text and the result obtained is segmented at the silent nodes in step (103). The next step (104) is to filter and classify the text obtained in step (103) to text with high (HCS) and low confidence score(LCS).

A unique feature of the instant invention is to distribute only the text with low confidence score to the transcriptionists for correction. This is done in step (105). Once the text is corrected by the transcriptionists, it is merged synchronously with the text having high confidence score. The merging is done according to timestamp marks so that the final text output file is an accurate text version of the source audio file.

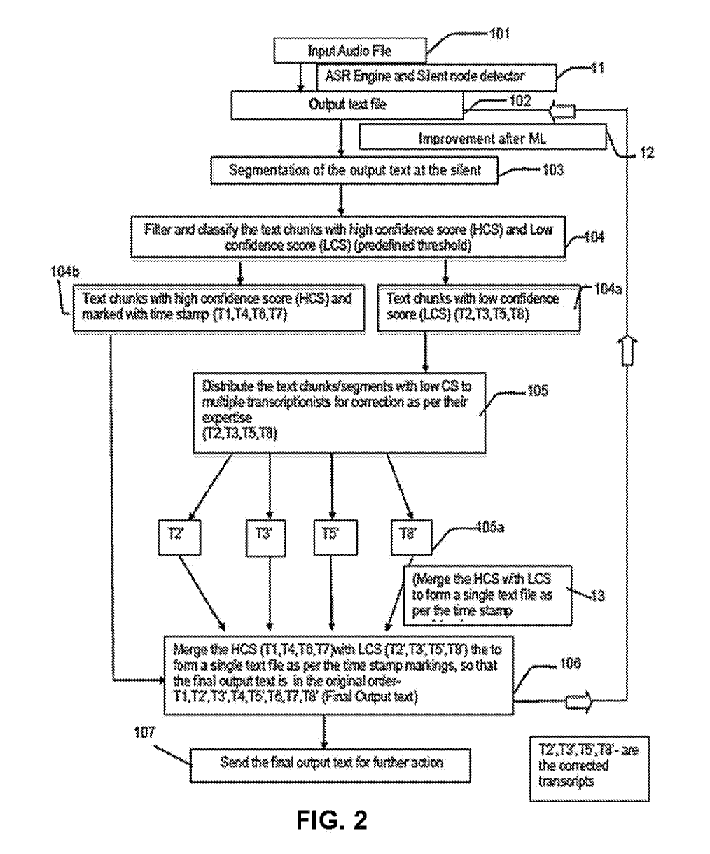

FIG. 2 explains the detailed process of reducing TAT. Once the segmentation of the output text is done at silent nodes in step (103), the said output text is filtered and classified into text with High Confidence Score (HCS) and text with low confidence score (LCS). The text is classified on the basis of predetermined threshold confidence score. This confidence score can be adjusted and is generally set between 80 to 95%. The text chunks are classified into two groups-text chunks with LCS(104a) and text chunks with HCS (104b). Once this classification is done, the text and audio with LCS (T2, T3, T5, T8) is distributed (105) to different transcriptionist(s) for error correction. Once the text is corrected by the transcriptionist(s) (T2′, T3′, T5′, T8′) in step (105a), it is merged synchronously with the HCS(104b) such that the resulting output text file (106) is an accurate version of the audio source file. This output text file can either be sent to QA for human correction or for any other process as the user deems fit.

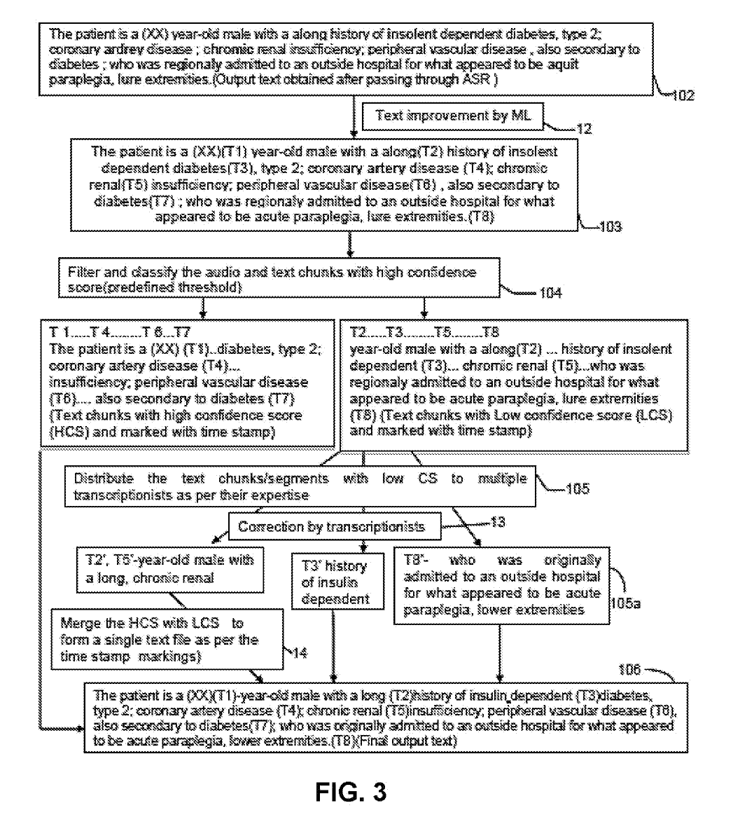

FIG. 3 explains the reduction of TAT with a hypothetical example. For practical purposes, the flowchart starts here at step (102) i.e. when the source audio file is converted to a text file by passing through integrated ASR engine and silent node detector. For illustrative purposes the possible errors are marked in bold. Some of the errors in the said text in step (102) are corrected by text improvement by machine learning and the output is obtained in step (103). This output text in step (103) is filtrated and classified on the basis of confidence score. The threshold confidence score is predetermined and is generally set between 80 to 95%. The words that have higher confidence score than 80% is classified as text with High Confidence Score, HCS (104b), and words with confidence score lower than 80% is classified as text with Low confidence score LCS (104a). The next step (105) is to distribute the text with LCS and the corresponding audio chunk for correction to the transcriptionist(s) as per their expertise and availability. Once the transcriptionist(s) correct the respective text chunk(s) these said chunks are merged synchronously with the HCS text chunks. The resulting output text file is an accurate text version of the source audio file. In one of the embodiments the output text file is sent for manual quality assurance and then delivered to the client.

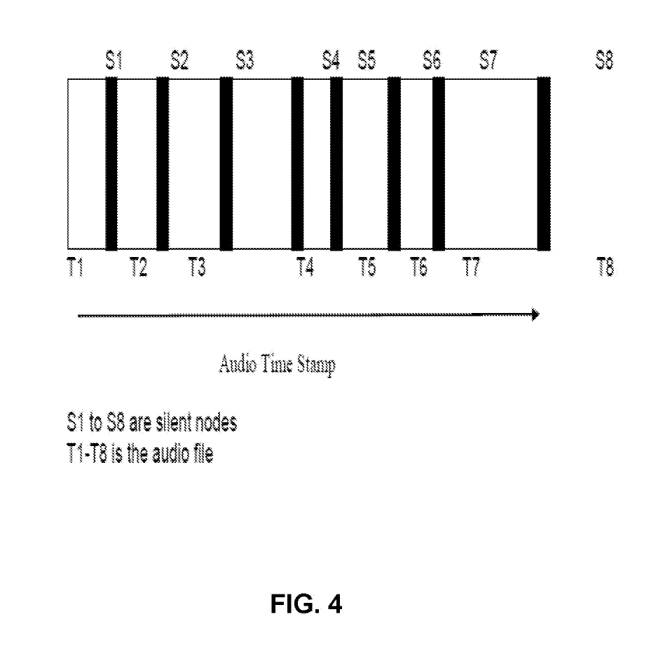

FIG. 4 is a graphical representation of the partitioning of the input source audio file. The tags S1-S7 indicate the silent nodes and the tags T1-T7 indicate the audio chunks. The segmentation of the audio file takes place at the silent nodes S1, S2, S3 S7. However, when the text and audio chunks are sent for transcription to multiple users, multiple silent nodes can be included in a single chunk.

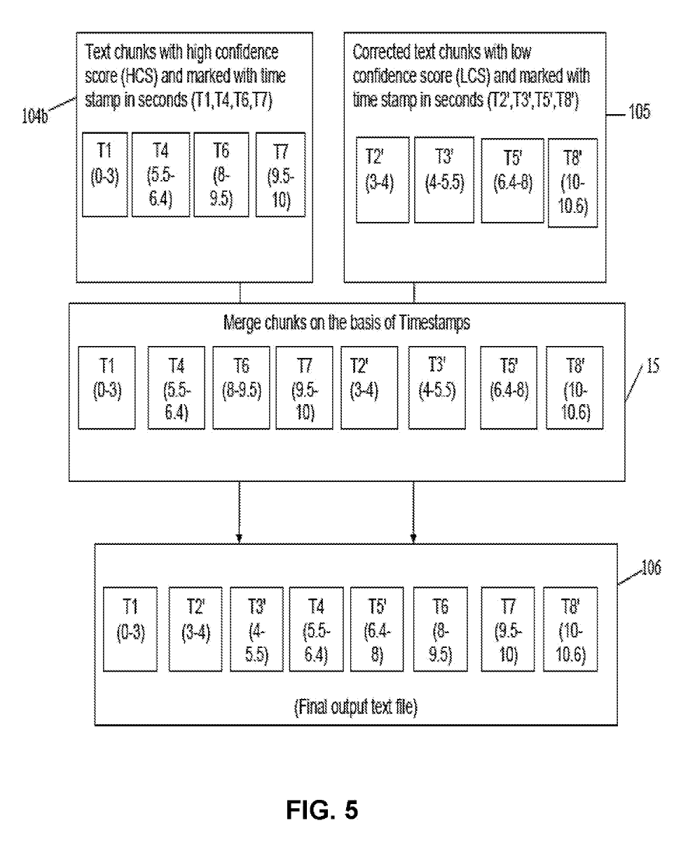

FIG. 5 depicts the procedure for merging and synchronizing the text with high confidence score with the corrected text chunks having low confidence score. Once the corrected text from different transcriptionists is received (105), it is rearranged with the text chunks from (104b) on the basis of time stamps in step (106).

1. A computer implemented method for reducing the Turn around time (TAT) for transcription of audio source file, comprising the steps of:
receiving source audio file and passing the source audio file through integrated Automatic Speech Recognition (ASR) engine and silent node detector for converting the source audio file to output text;
improving the output text by machine learning;
segmenting the output text file to text chunks at silent nodes;
filtering and classifying the segmented text chunks to high confidence score chunks and low confidence score chunks, on basis of predetermined threshold confidence score;
distributing the text chunks with low confidence score and corresponding audio chunks to multiple users for correction; and
merging the corrected text with the text chunks having the high confidence score to obtain a final single text output file that is synchronous with source audio file.

2. The computer implemented method of claim 1, wherein the audio and text file segmenting takes place at corresponding position.

3. The computer implemented method of claim 1, wherein the segmentation of the audio file takes place at silent nodes.

4. The computer implemented method of claim 1, further comprising the method of distributing the text and audio files to the multiple users as per expertise of the multiple users.

5. The computer implemented method of claim 1, wherein the final text output file is sent for quality assurances for correcting the unnoticed mistakes.

6. The computer implemented method of claim 1, wherein a feedback mechanism comprises of capturing the data and matrices for machine learning that is used in the improvement of text output.

7. The computer implemented method of claim 1, wherein the merging of the text files is done according to time stamps.
